(19) United States
(12) Patent Application Publication
(10) Pub. No.: US 2008/0302672 A1
(43) Pub. Date: Dec. 11, 2008

(54) SYSTEMS AND METHODS FOR SENSING

(75) Inventors: Peter Micah Sandvik, Clifton Park, NY (US); Radislav Alexandrovich Potyrailo, Niskayuna, NY (US); Vinayak Tilak, Niskayuna, NY (US); John Patrick Lemmon, Schoharie, NY (US); Elena Babes-Dornea, Pierrefonds (CA); Yves Grincourt, Ottawa (CA); Charles-Olivier Fournier, Montreal (CA)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/758,179

(22) Filed: Jun. 5, 2007

(51) Int. Cl. G01N 27/26

(52) U.S. Cl. 205/775; 204/406

(57) ABSTRACT

A sensor system for measuring a plurality of chemical species is disclosed. The sensor system includes a plurality of semiconductor device sensor elements, wherein each sensor element includes at least one wide band gap semiconductor layer and at least one catalytic layer configured to have an electrical property modifiable on exposure to an analyte including one or more chemical species; and an acquisition and analysis system configured to receive sensor signals from the plurality of sensor elements and to use multivariate analysis techniques to analyze the sensor signals to provide multivariate analyte measurement data.

### BACKGROUND

The invention relates generally to the field of analyte sensors.

Sensors have been used in the detection of particular symptomatic chemical species in oil-filled electrical equipment, for example. Faults in oil-filled transformers may include electrical arcing, corona discharge, low energy sparking, electrical overloading, pump motor failure, and overheating in an insulation system. Faults may generate undesirable chemical species, such as hydrogen (H₂), acetylene (C₂H₂), ethylene (C₂H₄), methane (CH₄), ethane (C₂H₄), carbon monoxide (CO) and carbon dioxide (CO₂). These fault conditions may result in a malfunctioning transformer and thus information about the chemical species may be used to predict an impending malfunction.

In other oil-filled embodiments in which high electrical fields or temperature oscillations cause the oil to break down into its potentially flammable constituents over time, sensors would be useful to detect symptomatic chemical species. One example of such equipment is an x-ray tube used in medical applications. These tubes, much like transformers, use oil to both insulate and cool internal electrical components.

In some applications, power transformers expose insulating oil to high electric fields that break down the oil over time. Hydrogen gas and hydrogen bearing compounds are released. If preventative maintenance is not provided, flammable hydrogen gas may build up in the system and, if ignited, may lead to system failure. Current detection systems for hydrogen are time consuming, expensive, offer incomplete information, and in some cases are only performed periodically throughout the year.

It would be desirable to have a sensing system including sensors that are robust in harsh environment conditions and in fluctuating environmental conditions, and sensors that exhibit reliable and concurrent detection of a plurality of chemical species.

### BRIEF DESCRIPTION

One embodiment disclosed herein is a sensor system for measuring a plurality of chemical species. The sensor system includes a plurality of semiconductor device sensor elements, wherein each sensor element includes at least one wide band gap semiconductor layer and at least one catalytic layer configured to have an electrical property modifiable on exposure to an analyte including one or more chemical species; and an acquisition and analysis system configured to receive sensor signals from the plurality of sensor elements and to use multivariate analysis techniques to analyze the sensor signals to provide multivariate analyte measurement data.

Another embodiment disclosed herein is a system for sensing chemical species in an oil-filled environment. The system includes a plurality of semiconductor device sensor elements, wherein each sensor element includes at least one wide band gap semiconductor layer and at least one catalytic layer configured to have an electrical property modifiable on exposure to an analyte including one or more chemical species, wherein the sensor elements are disposed within the oil-filled environment and configured to selectively detect one or more chemical species and provide multivariate sensor signals; and an acquisition and analysis system configured to receive sensor signals from the plurality of sensor elements and to use multivariate analysis techniques to analyze the sensor signals to provide multivariate analyte measurement data, wherein the acquisition and analysis system is disposed external to the oil-filled environment.

Another embodiment of the present invention is a method for sensing a plurality of species. The method includes generating sensor signals from a plurality of semiconductor device sensor elements, wherein each sensor element comprises at least one wide band gap semiconductor layer and at least one catalytic layer configured to have an electrical property modifiable on exposure to an analyte comprising one or more chemical species; analyzing the plurality of sensor signals using multivariate analysis techniques; and generating analyte data, wherein the analyte data comprises the analyte composition and analyte concentration.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a sensor system in one embodiment disclosed herein.

FIG. 2 is a schematic representation of a sensor system in another embodiment disclosed herein.

FIG. 3 is a diagrammatic representation of a sensor system in another embodiment disclosed herein.

FIG. 4 is a schematic representation of a sensor element in one embodiment disclosed herein.

FIG. 5 is a schematic representation of a sensor element in another embodiment disclosed herein.

FIG. 6 is a schematic representation of a sensor element in another embodiment disclosed herein.

FIG. 7 is a flow chart illustration of a multivariate analysis technique in one embodiment disclosed herein.

### DETAILED DESCRIPTION

Embodiments of the present invention include sensor systems and methods for sensing chemical species in an analyte.

In the following specification and the claims that follow, reference will be made to a number of terms which shall be defined to have the following meanings. The singular forms “a”, “an” and “the” include plural referents unless the context clearly dictates otherwise. The term “multivariate analysis” refers to a collection of events which involve observation and analysis of more than one statistical variable at a time. In one example, output signals from several sensor elements are manipulated to obtain a first statistical variable, and output signals from the same or a different group of sensor elements may be manipulated to obtain a second statistical variable. In another example, a plurality of variables may be obtained from a single sensor element. In some embodiments, the application of multivariate analysis provides the capability to improve the selectivity of determinations by reducing the response from interferences. Further, in many situations, multivariate analysis improves sensor signal-to-noise. As used herein, the term “sensitivity” is a measure of the modification to the sensor electrical properties that result from the interaction of the species at a certain concentration when in contact with the sensor. As used herein, selectivity is the difference or ratio in sensitivity of a device element to different chemical species.

Although the embodiments of the sensor system described herein may be described with sensor elements operating in electrically non-conductive oil, such as in power transformer or x-ray tube oil reservoirs, these are merely example applications for the sensor system. The sensor system may alternatively operate in air. For example, in one embodiment, the sensor system is included within an exhaust gas monitoring system for applications such as gas turbines, diesel locomotives, and aircraft engines.

In one embodiment, a sensor system includes one or more semiconductor device sensor elements each providing an output signal. The sensor system further includes a data acquisition and analysis system configured to receive the output sensor signals from the sensor elements and to provide analyte measurement data, wherein the acquisition and analysis system is configured to use multivariate analysis techniques to provide multivariate analyte measurement data. The analyte measurement data may include chemical species composition, chemical species concentration, or combinations thereof, for example.

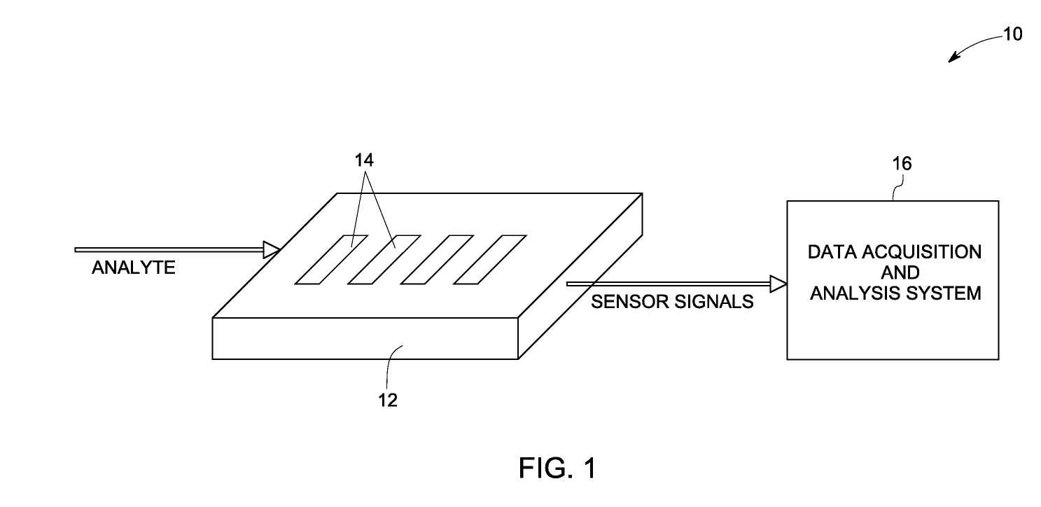

FIG. 1 illustrates a sensor system 10 in one embodiment including a sensor module 12. The sensor module in the illustrated embodiment of FIG. 1 includes a plurality of semiconductor device sensor elements 14. An analyte flowing across the sensor module 12 is sensed by the plurality of sensor elements 14. Sensor signals from each of the sensor elements are led from the sensor module to a data acquisition and analysis system 16. Such signals may be sent either in parallel or in series to the data and acquisition and analysis system 16.

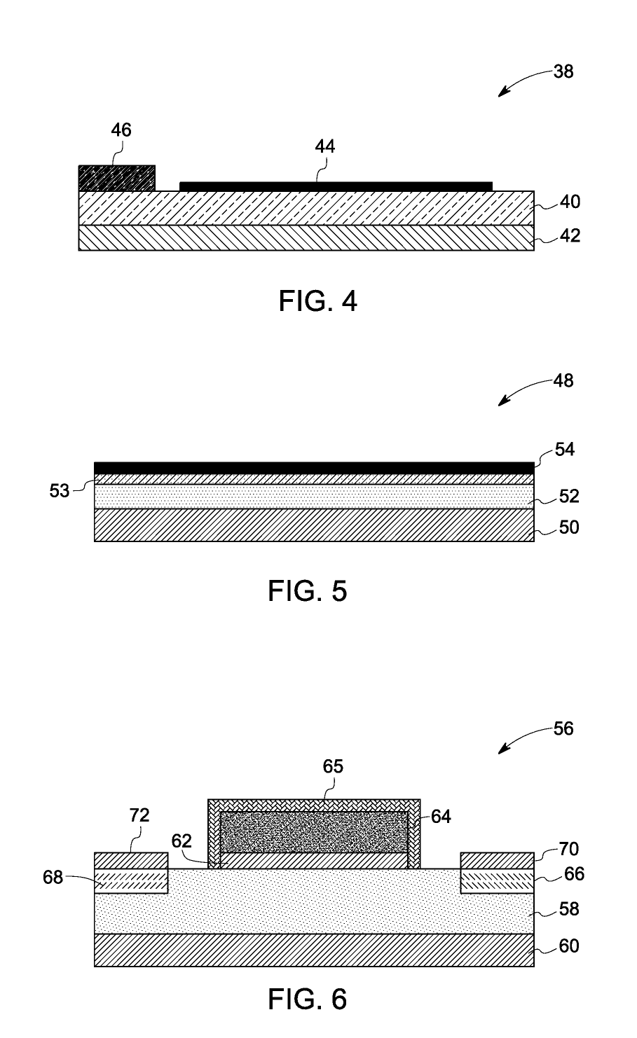

Semiconductor device sensor elements 14 may include at least one catalytic layer and at least one wide band gap semiconductor layer (as shown in FIGS. 4-6). As used herein, the term wide band gap refers to a band gap of at least 2 eV. Non-limiting examples of wide band gap semiconductor layer materials include group-III, IV and V materials. In a more specific embodiment, the semiconductor layer is be a group-III layer material such as but not limited to binary alloys such as GaN, GaAs, InN, and AlN, ternary alloys such as AlGaN and quaternary alloys such as InGaN and AlInGaN. Other semiconductor layer materials include diamond, silicon carbide, zinc oxide and boron nitride. In one embodiment, the materials are chosen for high temperature operation. Materials such GaN and SiC are both resistant to harsh environments and capable of operation at high temperatures such as over about 150 degrees Celsius. In addition, the chemical inertness of GaN and SiC gives them a high resistance to etching and degradation, even in the presence of strong acids or bases. Different semiconductor materials may be combined to achieve differing responses and sensitivities in single sensor elements or arrays of sensor elements.

The catalytic layer may include one or more materials such as but not limited to platinum, palladium, iridium, ruthenium, nickel, copper, rhodium, molybdenum, iron, cobalt, titanium, vanadium, tantalum, tungsten, rhenium, chromium, manganese, gold, silver, aluminum, palladium:silver, tin, osmium, magnesium, zinc, alloys of these materials, mixtures of these materials or combinations thereof. Some additional examples include WO₃, Pd, Fe₂O₃, Fe:Mg, PdO, In₂O₃—SnO₂, PtO_{X}, AgO_{X}, InO_{X}, SnO_{X}, VO_{X}, IrO_{X}, TiO_{X}. The catalytic layer may be present as a thin solid nonporous film, porous film, mesoporous film, nanoporous film, nanowire film, nanoparticle film, nanopattemed film, or any combination thereof.

For example, the catalytic layer in each sensor element may be functionalized to respond to one or more or combinations of species. Different catalytic materials possess different sensitivities to various gases of interest, making the single sensor system 10 operable for detecting several gaseous elements, distinguishing between them and determining concentrations. The plurality of sensor elements may include different catalytic layer materials to enable sensing a plurality of chemical species by the sensor system. In one embodiment, a catalytic layer may have a thickness in a range from 5 nm to 100 nm. In a further embodiment, the thickness may range from 8 nm to 50 nm. In a still further embodiment, the thickness is 20 nm. The level of sensitivity for each gas may be different for each particular catalytic layer material, and the thickness may be chosen to achieve a desirable level of sensitivity from the catalytic layer material. In one embodiment, the sensor element may be tuned to a particular chemical species by virtue of the catalytic material used and/or by the surface geometry and/or area of the layer.

In one embodiment, each of the catalytic layers is configured to be responsive to one or more or combinations of chemical species such as but not limited to hydrogen, carbon monoxide (CO), carbon dioxide (CO₂), oxygen, H₂O, C₂H₂ (acetylene), C₂H₄ (ethylene), CH₄ (methane), C₂H₆ (ethane), and combinations thereof. In one embodiment, as shown in FIGS. 4-6, the catalytic layer forms an electrode in the semiconductor device sensor element.

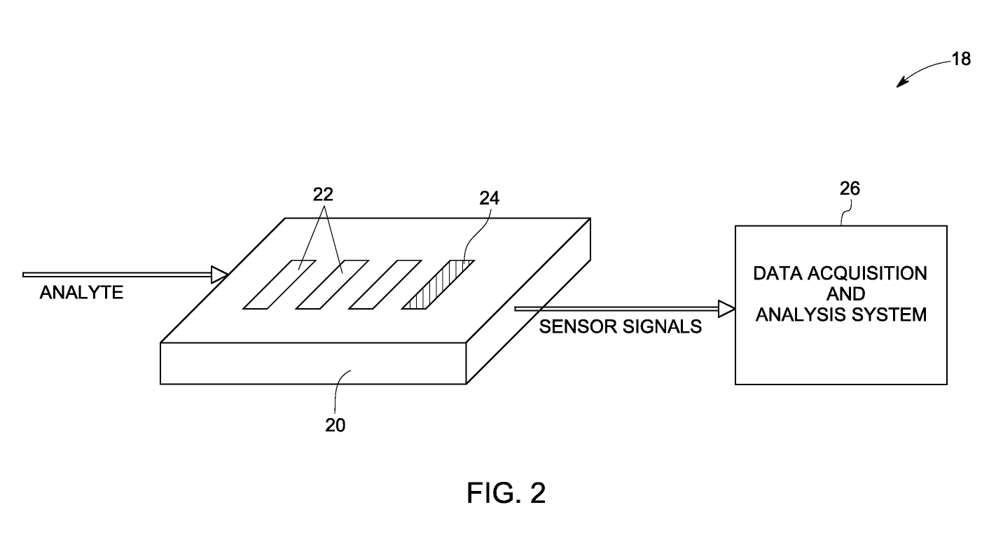

FIG. 2 illustrates a sensor system 18 in another embodiment wherein sensor module 20 includes a plurality of semiconductor device sensor elements 22 and further includes a physical sensor 24. Non-limiting examples of physical sensors include temperature sensors, flow sensors, humidity sensors, and pressure sensors. An analyte flowing across the sensor module 20 is sensed by the plurality of sensor elements 22. Sensor signals, from each of the plurality of sensor elements 22 and sensor signals from the physical sensor 24 are led from the sensor module 20 to the data acquisition and analysis system 26.

In one embodiment, the semiconductor device sensor element comprises a capacitor, a diode, or a transistor. A non-limiting example of a diode is a Shottky diode, where the catalytic layer forms the metal electrode. Another example of a semiconductor device sensor element is a capacitor such as a MOS (metal oxide semiconductor) capacitor. Transistor examples include a field effect transistor (FET) such as a MISFET (Metal-insulator semiconductor FET), a MOSFET (Metal-oxide-semiconductor FET), a HFET (heterostructure FET), a MOSHFET (Metal-insulator-semiconductor heterostructure FET), a MESFET (Metal-semiconductor FET), or a HEMT (high electron mobility transistors), where the catalytic layer forms a gate electrode. In a non-limiting example, the sensor elements may be fabricated on a single substrate. Alternatively, each sensor element or smaller groups of sensor elements may be fabricated on different substrates and used in combination.

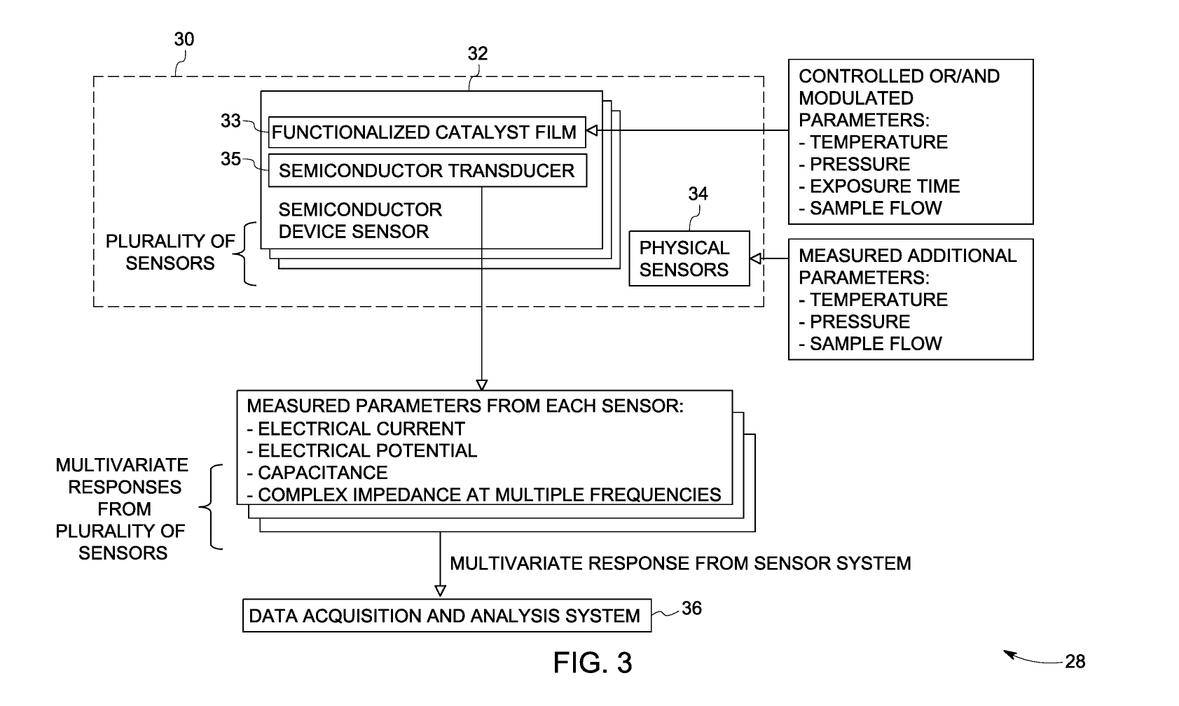

FIG. 3 diagrammatically illustrates a sensor system 28 and the information inflow and outflow from the sensor system in one embodiment. The sensor system includes a sensor module 30 including a plurality of sensor elements 32. Each sensor element of the plurality of sensor elements 32 is a semiconductor device sensor element including a functionalized catalytic film 33 and a semiconductor transducer 35, which provides a sensor response in the form of, for example, current, voltage, complex impedance at multiple frequencies, and/or capacitance from which multivariate analyte measurement data may be obtained. System parameters such as but not limited to temperature, pressure, exposure time, and sample flow may be controlled and/or modulated to vary the performance of each of the sensor elements. The system also includes one or more physical sensors 34. Here the physical sensors may be used to measure physical parameters such as but not limited to temperature, pressure, and sample flow. The responses of the both the sensor elements 32 and the physical sensors 34 are acquired and processed by the data acquisition and analysis system 36.

Standard techniques may be used to fabricate the sensor elements. Standard fabrication techniques are described in many references, such as “Sandvik et al., Physica Status Solidi C, vol. 3, no. 6, p. 2283-2286, 2006”.

In one embodiment, the one or more sensor elements used in the sensor system include Schottky diodes. FIG. 4 illustrates a sensor element comprising a Schottky diode 38. The Schottky diode 38 includes a semiconductor layer 40 disposed over the substrate 42. Over the semiconductor layer 40 a catalytic layer forming an electrode 44 is deposited to form the Schottky junction. An ohmic contact 46 is disposed in contact with the semiconductor layer 40.

In another embodiment, one or more sensor elements used in the sensor system include a capacitor. FIG. 5 illustrates a sensor device comprising a MOS capacitor 48. The capacitor 48 includes a semiconductor substrate 50 with a dielectric layer 52, for example an oxide layer, disposed over the semiconductor substrate 50. A catalytic layer 54 is disposed over the dielectric layer 52 to form the sensor element.

In some embodiments, a sensor element includes a passivation layer. In one example, the passivation layer may act to improve the thermal stability and reproducibility of the sensor element. The passivation layer may comprise, for example, MgO, Sr₂O₃, ZrO2, Ln₂O₃, TiO₂, AlN, and/or carbon. In another example, a passivation layer may be used on the surface of the sensor element to passivate any dangling bonds at the surface and reduce leakage currents. For example, a passivation layer 53 may be disposed over the semiconductor layer and under the catalytic layer as illustrated in FIG. 5. Non-limiting examples of passivation layer materials include silicon nitride, silicon dioxide, silioxynitride, hafnium oxide, titanium oxide, indium doped titanium oxide, aluminum oxide, gallium oxide or combinations thereof. For example, a silicon nitride (Si₃N₄) passivation layer may help mitigate effects of surface states that may potentially cause false signals due to an interaction of the surface states with positive ions other than hydrogen. The Si₃N₄ layer thereby may help increase the selectivity to hydrogen as the hydrogen interacts with the semiconductor layer by diffusing through the catalytic layer, whereas the other large molecules are prevented from interacting with the semiconductor surface.

In still another embodiment of the present invention, one or more sensor elements used in the sensor system comprise field effect transistors. FIG. 6 illustrates a MOSFET 56 wherein semiconductor layer 58 is disposed over the substrate layer 60. Gate insulator layer 62 is formed over the semiconductor layer 58 and the catalytic gate electrode 64 is formed over the gate insulator layer 62.

In some embodiments, a sensor element includes a filter to vary a concentration of the one or more chemical species in the analyte before detection by the sensor element. Non-limiting examples of filters include selective ion permeable filters and selective gas permeable filters. For example, improvements to sensitivity may be accomplished by adding a polytetrafluoroethylene or polyimide cover over the sensor element. A filter layer 65 is disposed surrounding the catalytic gate layer 64 as illustrated in FIG. 6. Source and drain contacts 70 and 72 are formed in contact with the source and drain regions 66 and 68 respectively.

In certain embodiments, the analyte includes one or more fluids. The one or more chemical species may be dissolved in the one or more fluids, wherein the sensor system is operable to determine the composition and concentration of the one or more chemical species dissolved in the one or more fluids. The one or more fluids comprises at least one gaseous phase or at least one liquid phase fluid. In some embodiments, the one or more of the plurality of sensor elements further include a gas permeable protective coating to protect the sensor elements from device incompatible fluids but allow permeation of the one or more chemical species dissolved in the one or more fluids. In one example, a thin film of TEFLON® polytetrafluoroethylene may be used which enables smaller gas molecules such as hydrogen to pass while blocking larger gas molecules such as oxygen. In one example a thin polytetrafluoroethylene film passes a ration 0:1 H₂/O₂. In another example, a film comprised of KAPTON® polyimide may be used, which may pass a ratio of 20:1 of H₂/O₂. In one embodiment, the thickness of the protective coating is less than 1 millimeter.

In one example, the system is configured for sensing chemical species in a fluid filled environment such as an oil-filled electrical equipment. Examples include detection of hydrocarbon gases dissolved in transformer oil and operation to detect gas-in-oil in x-ray tubes. In one example, the sensor elements are disposed within the oil-filled environment, each sensor element is configured to selectively detect one or more chemical species and to provide sensor signals. In a further example, the acquisition and analysis system is disposed external to the oil-filled environment.

In one embodiment, the semiconductor device sensor element may be operated and its output signal measured in a direct current mode. Alternatively, the semiconductor device sensor element may be operated and the output signal measured in an alternating current mode. In a more specific example, the alternating current mode operation may include operating at a single frequency, at a plurality of frequencies, or continuously over a range of frequencies.

In one embodiment, a system response for a detected chemical species is in a range from about 300 ppm to about 1 ppm. The slope of the system response versus analyte concentration gives a measure of the sensitivity of the system. In a further embodiment, the system response for a detected chemical species is in a range from about 1 ppm to 100% of a gas in a gas mixture. In yet another embodiment, a system response for a detected chemical species is in a range from about 50000 ppm to 1 ppm of gas (for example Hydrogen) dissolved in the oil.

In one embodiment, sensor element characteristics such as selectivity and sensitivity can be varied. Selectivity or sensitivity can be varied by modifying parameters such as but not limited to bias voltage, analyte flow rate, and temperature. For example, at least one heating element may be present proximate to the sensor element or in particular proximate to the catalytic layer to vary an operating temperature leading to variation in device sensitivity or selectivity. The heating element might include, for example, a wire of titanium and/or nickel and may be used to hold the device to a substantially constant temperature during operation.

In one embodiment, the sensor elements are disposed within a harsh environment such as an environment having high pH values, high or varying temperatures, high electric or magnetic fields, or combinations thereof fields, or combinations thereof

In another embodiment, a method for sensing a chemical species is disclosed. The method includes detecting one or more chemical species using a plurality of semiconductor device sensor elements. Each sensor element of the plurality of semiconductor device sensor elements is configured to selectively detect a chemical species, or to selectively detect a combination of chemical species, or to detect one or more chemical species or combination with other sensors, and to provide a sensor signal. The electrical property of the semiconductor layer is modified on exposure to the one or more chemical species, and a plurality of signals from the plurality of semiconductor device sensor elements is generated. The plurality of sensor signals is analyzed using multivariate analysis techniques, and analyte data about the chemical species composition and concentration is determined.

In one embodiment, the system is configured to detect and analyze multivariate responses from the sensor element. For example, more than one sensor response or output may be detected and analyzed. For example, two or more sensor responses such as but not limited to voltage, current, potential, resistance, conductance, capacitance, inductance, impedance, complex impedance may be detected from each sensor element and analyzed.

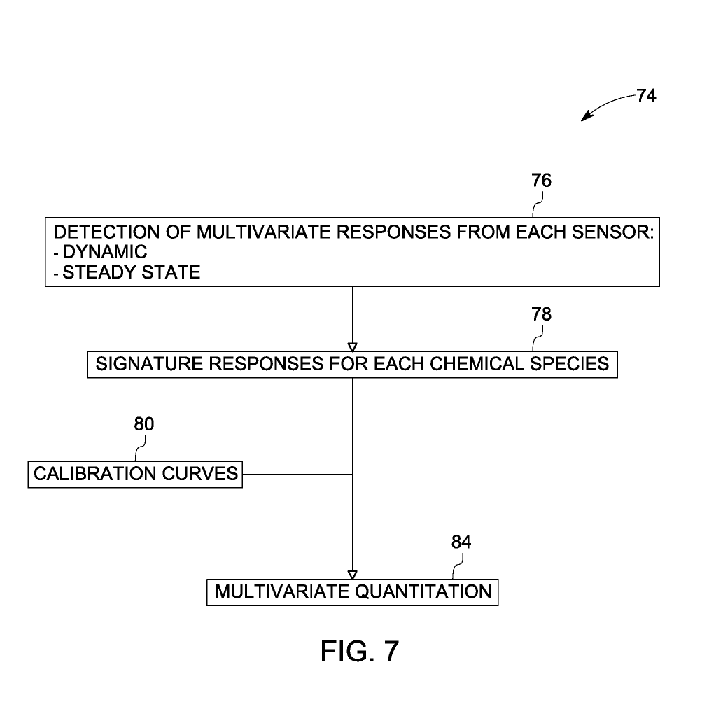

FIG. 7 is a flow chart illustration of a multivariate analysis technique in one embodiment of the present invention. The multivariate analysis technique 74 includes the step of detection of multivariate response from each sensor element 76. The detection can be done under dynamic conditions or steady state conditions. The signature response from each of the detected chemical species 78 is compared with previously obtained calibration curves 80 and multivariate quantitation is performed to identify the different chemical species and their concentrations.

Nonlimiting examples of multivariate analysis tools applied to quantify the concentrations of species of interest include canonical correlation analysis, regression analysis, principal components analysis, discriminant function analysis, multidimensional scaling, linear discriminant analysis, logistic regression, and/or neural network analysis.

Multivariate analysis techniques are especially applicable where a plurality of sensor elements is employed since the amount of information produced by the plurality of sensor elements can be substantial. To that end, multivariate analysis techniques offer several advantages over univariate analysis techniques. In one embodiment, signal averaging is achieved since more than one measurement channel is employed in the analysis. Also, the concentrations of multiple species may be measured. A calibration model is built by using responses from calibration standards. The analysis of unknown samples may be a challenge if a species is present in the sample that is not accounted for in the calibration model. This is mitigated somewhat by the ability to detect whether a sample is an outlier from the calibration set. Multivariate analysis approaches permit concurrent and selective quantitation of several chemical species of interest in an analyte. Multivariate analysis is advantageous when interferences using low-resolution instruments such as sensor elements with sensing films and when overlapping responses from different species preclude the use of univariate analysis.

In one embodiment, a principal components analysis (PCA) technique is used to extract the desired descriptors from dynamic analyte measurement data. PCA is a multivariate data analysis tool that projects the data set onto a subspace of lower dimensionality with removed co-linearity. PCA achieves this objective by explaining the variance of the data matrix X in terms of the weighted sums of the original variables with no significant loss of information. These weighted sums of the original variables are called principal components (PCs). Upon applying the PCA, the data matrix X is expressed as a linear combination of orthogonal vectors along the directions of the principal components:

X=t₁p^{T}₁+t₂p^{T}₂+ . . . +t_{A}p^{T}_{K}+E (Equation 1)

where tᵢ and pᵢ are, respectively, the score and loading vectors, K is the number of principal components, E is a residual matrix that represents random error, and T is the transpose of the matrix. Prior to PCA, the data may be preprocessed, such as by auto scaling.

Statistical tools may further be applied to enhance the quality of the sensor data analyzed using multivariate tools. Examples of such statistical tools include multivariate control charts and multivariate contributions plots. Multivariate control charts use two statistical indicators of the PCA model, such as Hotelling's T² and Q values plotted as a function of combinatorial sample or time. The significant principal components of the PCA model are used to develop the T²-chart and the remaining PCs contribute to the Q-chart. The sum of normalized squared scores, T² statistic, gives a measure of variation within the PCA model and determines statistically anomalous samples:

T²ᵢ=tᵢλ−1 tᵢ^{T}=xᵢPλ−1P^{T}xᵢ^{T} (Equation 2)

where tᵢ is the i^{th} row of Tk, the matrix of k scores vectors from the PCA model, λ−1 is the diagonal matrix containing the inverse of the eigenvalues associated with the K eigenvectors (principal components) retained in the model, xᵢ is the i^{th} sample in X, and P is the matrix of K loadings vectors retained in the PCA model (where each vector is a column of P). The Q residual is the squared prediction error and describes how well the PCA model fits each sample. It is a measure of the amount of variation in each sample not captured by K principal components retained in the model:

Qᵢ=eᵢeᵢ^{T}=xᵢ(I−Pk Pk^{T})xᵢ^{T} (Equation 3)

where eᵢ is the i^{th} row of E, and I is the identity matrix of appropriate size (n×n).

In one embodiment a selectivity and/or sensitivity of a semiconductor device sensor element can be dynamically modified. In a non-limiting example, a sensitivity and/or selectivity of a semiconductor device can be modified by varying a bias voltage applied to the sensor element. In another example, a variation of the flow of the analyte across the semiconductor device results in variation in the sensor element sensitivity and selectivity. In one example, the selective detection is a semi-selective detection. A semi-selective detection is detection when a sensor element responds to different species with different response magnitude. For example, the sensor element responds to an interfering species with a response magnitude that is a non-zero fraction of the response magnitude of the analyte species of interest. Thus, in some situations, a single sensor element cannot be used for accurate detection of analyte species in expected presence of an unknown concentration of an interfering species.

In one embodiment, the method of sensing one or more chemical species includes altering the one or more chemical species as the species comes into contact with the catalytic layer and the species may undergo atomically or molecularly altering of the chemical structure. For example, in the detection of hydrogen gas molecules (H₂), the hydrogen molecules are adsorbed onto a metallic gate-electrode from the analyte. The adsorbed molecules are altered, such as by being catalytically dissociated from each other on a molecular or atomic level. For hydrogen gas (H₂), the molecules (H₂) are dissociated into individual hydrogen atoms (H) and the atomic hydrogen diffuses through the catalytic layer to modify a response from the signal.

In a further embodiment, the method includes calibrating the one or more sensor elements for their selectivity and sensitivity under operating conditions. In a non-limiting example, the calibration of the devices is made by recording the signals of the devices installed in the environment, configuration, and conditions, which are representative of the operating conditions of the device. The calibration may be done in gas phase, in mixture of the gases of interest, and at different level of concentrations within the range of concentration for which the devices are specified. The calibration, in another example, may be done in dielectric oil in which the gases of interest are dissolved and at different levels of concentration within the range of concentration for which the devices are specified. In addition to calibrating for the gas concentration, calibration may also be performed for temperature, pressure, and flow. The recorded calibration device signals are analyzed using the multivariate regression techniques, which will be used for the calculation of the gas concentrations during the sensor element operation.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A sensor system comprising:
a plurality of semiconductor device sensor elements, wherein each sensor element comprises at least one wide band gap semiconductor layer and at least one catalytic layer configured to have an electrical property modifiable on exposure to an analyte comprising one or more chemical species; and
an acquisition and analysis system configured to receive sensor signals from the plurality of sensor elements and to use multivariate analysis techniques to analyze the sensor signals to provide multivariate analyte measurement data.

2. The sensor system of claim 1, wherein the one or more chemical species is at least one species selected from the group consisting of hydrogen, carbon monoxide (CO), carbon dioxide (CO₂), oxygen, H₂O, C₂H₂ (acetylene), C₂H₄ (ethylene), CH₄ (methane), C₂H₆ (ethane), and combinations thereof.

3. The sensor system of claim 1, wherein the catalytic layer comprises at least one film selected from the group consisting of a solid nonporous film, a porous film, mesoporous film, a nanoporous film, a nanowire film, a nanoparticle film, nanopatterned film, and combinations thereof.

4. The sensor system of claim 1, wherein the catalytic layer comprises a material comprising platinum, palladium, iridium, ruthenium, nickel, copper, rhodium, molybdenum, iron, cobalt, titanium, vanadium, tantalum, tungsten, rhenium, chromium, manganese, gold, silver, aluminum, palladium:silver, tin, osmium, magnesium, zinc, alloys of these materials, or combinations thereof.

5. The sensor system of claim 1, wherein the semiconductor layer comprises a material having a band gap greater than or equal to 2 eV.

6. The sensor system of claim 1, wherein the semiconductor layer comprises a material comprising GaN, AlGaN, InGaN, AlInGaN, GaAs, SiC, ZnO, diamond, boron nitride, or any combination thereof.

7. The sensor system of claim 1, wherein the sensor signal comprises a measure of the response of the semiconductor device, wherein the response is at least one parameter selected from group consisting of voltage, current, potential, resistance, conductance, capacitance, inductance, impedance, complex impedance and combinations thereof.

8. The sensor system of claim 1, wherein the response of the semiconductor device is measured in an alternating current mode and wherein the alternating current mode comprises operating at a single frequency, at a plurality of frequencies, or continuously over a range of frequencies.

9. The sensor system of claim 1, wherein the at least one sensor element comprises a device selected from the group consisting a capacitor, a diode, a transistor, and combinations thereof.

10. The sensor system of claim 1, further comprising a filter to vary a concentration of the one or more chemical species in the analyte before detection by at least one of the semiconductor device sensor elements.

11. The sensor system of claim 1, further comprising a passivation layer disposed over the semiconductor layer and under the catalytic layer.

12. The sensor system of claim 1, further comprising a control system for varying at least one of a selectivity and a sensitivity of the one or more sensor elements for the one or more chemical species.

13. The sensor system of claim 1, further comprising at least one physical property sensor configured to measure at least one physical property of the analyte.

14. The sensor system of claim 1, wherein the analyte comprises one or more fluids.

15. The sensor system of claim 14, wherein the one or more chemical species is dissolved in the one or more fluids, wherein the sensor system is operable to determine the composition and concentration of the one or more chemical species dissolved in the one or more fluids.

16. The sensor system of claim 1, wherein the sensor system is operable for detection of hydrocarbon gases dissolved in transformer oil.

17. The sensor system of claim 1, wherein the sensor system is operable for detection of gas-in-oil in x-ray tubes.

18. The system of claim 1, wherein the analyte measurement data comprises data comprising chemical species composition, chemical species concentration or combinations thereof.

19. A system for sensing chemical species in an oil-filled environment comprising:
a plurality of semiconductor device sensor elements, wherein each sensor element comprises at least one wide band gap semiconductor layer and at least one catalytic layer configured to have an electrical property modifiable on exposure to an analyte comprising one or more chemical species, wherein the sensor elements are disposed within the oil-filled environment and configured to selectively detect one or more chemical species and provide sensor signals; and
an acquisition and analysis system configured to receive sensor signals from the plurality of sensor elements and to use multivariate analysis techniques to analyze the sensor signals to provide multivariate analyte measurement data, wherein the acquisition and analysis system is disposed external to the oil-filled environment.

20. The system of claim 19, further comprising a fault monitoring system configured to monitor a variation in a concentration or a composition of the oil-filled environment with time.

21. A method for sensing a plurality of gases comprising:
generating sensor signals from a plurality of semiconductor device sensor elements, wherein each sensor element comprises at least one wide band gap semiconductor layer and at least one catalytic layer configured to have an electrical property modifiable on exposure to an analyte comprising one or more chemical species;
analyzing the plurality of sensor signals using multivariate analysis techniques; and
generating analyte data, wherein the analyte data comprises the analyte composition and analyte concentration.

22. The method of claim 21, further comprising varying a chemical species sensitivity or selectivity of one or more of the plurality of semiconductor device sensor elements.

23. The method of claim 22, further comprising varying an operational temperature of one or more of the plurality of semiconductor device sensor elements to vary a sensitivity or selectivity of the one or more plurality of semiconductor devices.

24. The method of claim 22, further comprising varying a bias applied to of one or more of the plurality of semiconductor device sensor elements to vary a sensitivity or selectivity of the one or more plurality of semiconductor devices.

25. The method of claim 21, further comprising varying a fluid flow across of one or more of the plurality of semiconductor device sensor elements.

26. The method of claim 21, further comprising altering the one or more chemical species as the one or more chemical species comes into contact with the catalytic layer, wherein altering comprises at least one of atomically or molecularly altering chemical structure of the one or more chemical species.

27. The method of claim 21, further comprising calibrating the one or more sensor elements for selectivity and sensitivity under a plurality of operating conditions.

28. The method of claim 21, wherein the multivariate analysis technique comprises at least one technique selected from the group consisting of canonical correlation analysis, regression analysis, principal components analysis, discriminant function analysis, multidimensional scaling, linear discriminant analysis, logistic regression, neural network analysis, and combinations thereof.
